(19) United States
(12) Patent Application Publication
(10) Pub. No.: US 2025/0069094 A1
(43) Pub. Date: Feb. 27, 2025

(54) SYSTEM AND METHOD FOR SECURE, PERMANENT AND TRACEABLE DIGITAL PROOF OF OWNERSHIP FOR UNIQUE PHYSICAL ITEMS

(71) Applicants: Adam Mark Weigold, Miami, FL (US); Melquiades Olivares, III, Las Vegas, NM (US); Naveen Rajamony-Kumar Sydney, Tucson, AZ (US); Mihkel Trink, Tallinn (EE)

(72) Inventors: Adam Mark Weigold, Miami, FL (US); Melquiades Olivares, III, Las Vegas, NM (US); Naveen Rajamony-Kumar Sydney, Tucson, AZ (US); Mihkel Trink, Tallinn (EE)

(73) Assignee: Decentryk Corporation, Miami, FL (US)

(21) Appl. No.: 18/236,743

(22) Filed: Aug. 22, 2023

(51) Int. Cl. G06Q 30/018; G06K 19/06

(52) U.S. Cl. CPC G06Q 30/0185; G06K 19/06028; G06K 19/06037

(57) ABSTRACT

The invention relates to a system and method for the digital authentication and/or digital enhancement of real-world physical items by integrating laser engraving, blockchain, optical scanning, multi-component code verification and information processing technologies to create permanent, secure, connected asset identifiers in both digital and physical formats for physical item anti-counterfeiting, anti-theft, item provenance and information storage applications. The present invention also relates to a system and method for the creation of unique non-fungible digital tokens which can be permanently connected or paired to unique physical items in the real world via the use of laser engraving techniques and multi-component information or QR code designs that are laser engraved on a physical item, and then optically scanned by anyone with a smartphone. The present invention also relates to a system and method that integrates non-fungible digital token software technology with laser engraving hardware techniques and multi-component information processing methods for the secure, permanent and traceable digital proof of ownership of a unique physical item, and also for physical data security protection against the forgery, copy or theft of unique digital information codes, digital asset data and non-fungible digital tokens that are connected or paired to unique physical items.

### CROSS-REFERENCE TO RELATED APPLICATIONS

This application is related to and claims priority under 35 USC.sctn.119 from U.S. Provisional Application No. 63/400,348 filed Aug. 23, 2022 entitled “SYSTEM AND METHOD FOR SECURE, PERMANENT AND TRACEABLE DIGITAL PROOF OF OWNERSHIP FOR UNIQUE PHYSICAL ITEMS” which is incorporated fully herein by reference.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable STATEMENT REGARDING PRIOR DISCLOSURES BY A JOINT INVENTOR

Not Applicable

### BACKGROUND OF THE INVENTION

### 1—Field of the Invention

The present invention relates to a system and method for the digital authentication and/or digital enhancement of real-world physical items by integrating laser engraving, blockchain, optical scanning, multi-component code verification and information processing technologies to create permanent, secure, connected asset identifiers in both digital and physical formats for physical item anti-counterfeiting, anti-theft, item provenance and information storage applications.

### 2—Description of Related Art

The use of unique non-fungible digital tokens as a secure permanent method for the proof of ownership of unique digital assets such as digital art, media files and collectible digital assets has recently gained large popularity in the fields of digital art, digital collectibles, entertainment, marketing, and computer gaming. Non-fungible tokens (or NFTs) are unique digital identifiers that are designed to be connected, paired or linked to unique digital assets, and securely cryptographically stored via immutable blockchain networks. When an NFT is initially created (or minted) it is permanently paired or linked to a unique digital asset such as a digital image file, media file or other digital asset type via a smart contract permanently recorded on a blockchain network. This digital pairing typically involves incorporating metadata information, such as an internet address or Uniform Resource Locator (or URL) related to the digital asset, into the smart contract of the minted NFT. The permanent pairing of an NFT with a digital asset via metadata written into the smart contract means that whoever owns the NFT also owns the digital asset. Hence the owner of a unique digital asset can sell it via the convenient and secure sale, auction or transfer of the NFT that is paired to the digital asset. The ownership and transaction history of the NFT is also permanently stored on the immutable blockchain network adding valuable item traceability and digital provenance. Consequently, NFTs have potential to grow the traceability and legitimacy of digital asset markets, including but not limited to digital art, collectibles, marketing and computer gaming.

It is important to note that while the NFTs and their related transactions can be created, stored and recorded in a secure, permanent and decentralized manner via blockchain technology, the digital assets they are paired to are often stored on unsafe centralized cloud storage platforms. Cyber-security for digital asset cloud storage platforms is a major issue to overcome for the entire NFT industry, and NFT related hacks are now commonplace. More importantly, because the metadata or URL for every NFT-linked asset is permanently written into the NFT's smart contract information that is public on a blockchain network, any person can easily locate and view the stored digital asset file for any NFT. While that person may not be able to edit or remove the digital asset file from its online location, they can very easily copy the digital asset via a “right-click-save” (or RCS) software operation. Hence all digital assets paired with minted NFTs are always publicly available to view by anybody via the internet and are very easily copiable and forgeable. This inherent lack of digital asset security and privacy (or the RCS flaw) is a fundamental design flaw or weakness for all NFT technologies that are used for verifying digital asset ownership. Regardless of the cyber-security weaknesses and the RCS flaw, millions of NFTs for digital assets are now being created and sold using many different NFT-compatible blockchain protocols including Ethereum and Solana blockchain protocols. The market for NFTs as a digital asset verification tool has grown to be worth several tens of billions of US dollars in annual sales over the last few years. In terms of published prior art, NFT technologies and designs for digital asset verification have been described in numerous online publications and patent applications including Tran et al (2021) in US Patent Application No. 20210256070.

More recently, attempts have also been made to securely and permanently connect NFTs to physical items in the real world. These physical asset applications for digital NFTs have used a machine-readable graphical information code such as a 1D barcode, 2D data matrix code or standardized quick response code (collectively referred to here as QR codes) as an intermediary data connection between the digital NFT and the physical item or asset. Typically, the same single QR code is used twice in both digital and physical formats. The QR code is used digitally to replace the digital asset in the smart contract, and it is used again physically by being printed directly on the physical asset (or printed on a label that is attached to the physical asset). By optically scanning the printed graphical QR code and converting it to a digital text data code (numeric, alpha-numeric or binary), the physical asset can be digitally paired to an NFT that is connected to the digital version of the same QR code.

By way of example, FIG. 1 is a schematic diagram of an illustrative prior art system and method for creating or minting NFTs for unique physical items. In this example a single QR code is used physically by printing it directly onto the physical item, or onto an adhesive label attached to the physical item. The same QR code is also used digitally by storing it to a publicly available online cloud storage provider and writing the metadata or URL for the stored QR code in the NFT smart contract created for the physical item, and the NFT private cryptographic keys are stored in the owners or user's digital wallet. Note that for the purpose of verification or ownership of the NFT or physical item, the owner or user simply needs to verify ownership of the NFT in their digital wallet, and they do not need to optically scan the physical QR code printed on the physical item. Consequently, the printing of the QR code on the physical item has no meaningful purpose for the verification process, and there exists no secure permanent link between the NFT and the physical item. Regardless of their fitness for purpose, the use of QR codes in prior art is not limited to 2D square QR codes and can be applied to any 1D or 2D graphical information code format. By way of additional example, FIG. 2 is a schematic of illustrative prior art for various possible examples of machine-readable graphical information codes, including 1) a 1D barcode, 2) a square 2D data matrix code, and 3) a circular 2D data matrix code (collectively referred to here as QR codes).

These systems and methods for creating NFTs for unique physical items with a single QR code have been attempted in several configurations in the prior art, including (a) ink printing or laser printing of QR codes on adhesive labels or tags for attaching to existing physical items, (b) ink or thermal printing of QR codes on fabric for fashion items by a fashion manufacturer, (c) printing of QR codes on the back of collectible paper stamps by a stamp manufacturer, and (d) printing or painting QR codes on the bottom of skateboards and sporting shoes by sporting goods manufacturers. In contrast to NFTs for digital assets, relatively few physical asset NFT techniques have been published and there is a scarcity of detailed published information available on NFTs designed for pairing with physical assets in the real world. Nonetheless, this conventional concept and method of printing a single QR code on a physical asset and linking that code to an NFT is gaining in popularity and usage. This simple method that uses a single QR code twice (once physically and once digitally) has also been briefly mentioned in Robertson et al (2021) in US Patent Application No. 20210133708. Furthermore, the concept of creating NFTs that are paired with event based digital lockers that are associated with the supply chain for physical real-world items such as sporting shoes has been discussed by Andon et al (2021) in U.S. Pat. No. 11,113,754.

The potential commercial market for securely and permanently linking digital NFTs to unique real-world physical items may ultimately be many times larger than the potential market for NFTs linked to unique digital assets. The potential NFT market for physical assets includes creating unique digital identifiers for luxury watches, unique jewelry, physical art pieces, fashion items, collectible wines, collectible sporting memorabilia, antiques, furniture, collectible vintage cars, luxury supercars, luxury yachts and even hi-end luxury real estate. A secure, legitimate NFT technology for physical assets could add around 20% to the total value of all unique luxury items that collectively are currently worth over US$500 Billon in total. Hence there exists obvious interest in the development of NFT technologies for physical luxury assets that could potentially be worth an additional US$100 Billion to physical luxury goods markets. Moreover, there may be many more potential applications and markets for non-luxury physical items, including but not limited to the use of NFTs for item tracking in transport, logistics and supply chain management systems of any physically shipped product.

Unfortunately there are many obvious design flaws and security weaknesses associated with creating and selling NFTs for unique physical items in the real world using a single QR code as an intermediary connection between digital and physical environments. In addition to the inherent cyber-security and RCS flaws relating to all NFTs for digital items, NFTs created for physical items demonstrate several additional design flaws and weaknesses that make them appear totally unfit for the purpose of digital verification use cases. These additional flaws relate to the identification, sale and transfer of assets using the same QR code twice, and to the use of non-permanent QR code printing techniques. Using conventional QR code management systems and methods described in the prior art, it appears that NFTs for physical assets are of much less real-world practicality and true value than NFTs for digital assets. Ultimately, when a person purchases an NFT for a physical asset they are effectively only buying a QR code instead of the ownership rights to the physical asset. Hence this is an additional difference and obvious weakness for NFTs for physical assets compared to NFTs for digital assets.

To summarize, there are five major design or implementation flaws with all prior art relating to the use of NFTs for physical items that use both a single information code or QR code as an intermediary connection between physical and digital environments, and standard printing technologies for printing information codes or QR codes on physical items. These fundamental flaws detrimentally affect the ownership security and legitimacy of the NFT and allow for the easy forgery of the physical asset via its paired QR code after the NFT is created. The five major design flaws or weaknesses exhibited by collective prior art for creating digital NFTs connected to physical items using a single information code or QR code as an intermediary link are described in (a), (b), (c), (d) and (e) as follows:
(a) The digital form of the QR code is often stored on a centralized cloud storage platform such as Google Drive, iCloud or AWS which are highly vulnerable to cyber-security attacks and frequently hacked. This design flaw is effectively identical to a fundamental flaw of all NFTs linked to unique digital assets in prior art. This means that the QR code can be easily edited, altered, copied or deleted by potential hackers of the centralized storage platform, regardless of the NFT's security and cryptographic key storage status.
(b) The digital form of the QR code is linked to the unique NFT via the NFT smart software contract and hence is publicly available to view by anyone who examines the relevant public blockchain information once the NFT is minted or created. This means that the QR code can be easily copied by anyone via a “right-click-save” software operation and consequently it is easy to forge the QR code due to this RCS flaw. This flaw is effectively identical to the fundamental flaw of all NFTs linked to unique digital assets, except that the digital asset is now replaced with a QR code or similar. Consequently, the legitimate QR code can be physically printed on a forgery of the unique physical item (or printed on a label that can be attached to a forgery of the unique physical item).
(c) An NFT linked to a physical asset via a single QR code can be sold, auctioned or transferred from one party to another without the actual sale or transfer of ownership of the physical asset it is supposed to be linked to. The ownership status of the NFT and the linked physical asset are effectively independent of each other. Consequently, there is no secure, permanent link or digital connection between a “paired” NFT and the physical item, regardless of QR code management or QR code printing methods. Moreover, the value of an NFT that is linked to a physical asset is of dubious or uncertain value as its ownership status is not linked to the ownership status of the physical item.
(d) The physical version of the QR code that is printed on the physical asset (or printed on a label that is attached to the physical asset) is rarely permanent, secure or tamper-proof because of flaws related to conventional printing methods on physical items. For example, ink printing or laser printing of QR codes on paper or fabric materials degrades or deteriorates over time depending on the quality of the physical material being printed on. Additionally, permanent ink or thermal printing of QR codes directly on the physical item is usually only viable during the construction phase of the item by the manufacturer. Furthermore, these techniques only work well for limited materials such as paper or fabrics. Ink printing, laser printing and thermal printing techniques do not work well for materials such as metals, glass, wood or plastic. Moreover, adhesive labels or attachable tags with QR codes printed on them can be easily removed, replaced, damaged or tampered with. Consequently, conventional printing techniques do not work for most materials used in most collectible and luxury physical items and is rarely suitable for any existing or pre-owned physical luxury items.
(e) The printed physical version of the QR code can be easily optically scanned or photographed, and then reproduced by anyone who has access to an image of the QR code or the physical item itself. Hence, the QR codes can be reproduced and printed on another physical item with identical or similar physical characteristics of the original item for the purpose of forgery of the original item. Scanning of the identical QR code on the forged physical item can result in a direct connection to the original minted NFT and hence falsely prove ownership of the physical item for the forger.

Consequently standard ink printing, thermal printing or laser printing of a single QR code on a unique physical item and then linking that same QR code digitally to an NFT is neither a permanent nor secure method for item identification and ownership provenance purposes. All conventional prior art suffers from a lack of identification permanence and asset security in both physical and digital environment formats. This is due to the use of the same QR code twice in both the physical and digital environments, and the use of inappropriate printing methods for the physical version of the QR code. Furthermore, this temporary and unsecure pairing of NFTs with physical items is generally applicable to only a few select materials such as paper, fabric or canvas and limited to implementation at the time of manufacture for any degree of physical permanence. These printable materials represent a very small fraction of the materials used in valuable luxury goods and collectible items that could potentially benefit from the secure pairing of a physical asset with an NFT (including watches, jewelry, cars, wine, antiques and physical art). There currently exists no satisfactory solution in the prior art for creating secure permanent QR codes and minting paired NFTs for physical items that are manufactured out of metal, glass, wood, leather or plastic. There also does not exist a satisfactory solution in prior art for creating digitally secure QR codes that can be permanently attached to or embedded into existing or pre-owned physical items made from materials such as metal, glass, wood, leather or plastic.

### SUMMARY OF THE INVENTION

The present invention provides for a system and method for the secure, permanent and traceable use of non-fungible tokens (or NFTs) for the digital proof of ownership, sale or transfer of a physical item in the real world. To achieve this objective the present invention combines the use of permanent laser engraving techniques with a novel multi-component information code (or QR code) processing and storage method that involves the use of irreversible hashing algorithms of two separate and different QR codes to produce a third unique QR code for the purpose of verification or transfer of NFT ownership, and by consequence physical asset ownership.

For the purposes of using a briefer nomenclature, we will hereunto refer to this novel and innovative multi-component QR code processing and verification method using 3 different QR codes as the “Hashed QR” method, process or technology. When combined with laser engraving and optical scanning techniques the Hashed QR method solves all five major fundamental flaws or weaknesses relating to all collective prior art for creating NFTs for physical items. These five weaknesses or flaws in all prior art have been detailed previously here as (a), (b), (c), (d) and (e) in paragraph [0009] and in the initial section titled “Background of the Invention”.

In practical application terms, this unique and novel method results in two different inter-dependent systems or processes that comprise (1) an NFT creation or minting process for physical assets using 3 different graphical QR codes and laser engraving techniques, and (2) an NFT verification process for physical assets using 3 different graphical QR codes and optical scanning techniques. It is the use of 3 different QR codes with the Hashed QR method, combined with laser engraving and optical scanning techniques, that form the most novel, innovative, practical and useful configurations of the present invention.

The fundamental innovation and novelty of the present invention compared with all prior art (that uses a single identical QR code twice) relates to the processing of three separate and different information data codes or QR codes for NFT minting and verification purposes. These three separate QR codes are separately used for the physical environment, for the digital environment, and for the purpose of verification of ownership for both the digital NFT and physical item. As an essential feature of the present invention, the QR code used for verification of ownership purposes is created via a mathematical combination of the physical QR code and the digital QR code using an irreversible hash algorithm. Using equivalent terminology, the verification QR code is the output of an irreversible hash algorithm that uses both the physical QR code and the digital QR code as inputs. It is important to note that the hash algorithm is irreversible, so that the two input QR codes cannot be determined from the output QR code.

The implementation and use of laser engraving technology for the physical QR code format is important for the practical application of the Hashed QR method with numerous physical materials used in valuable luxury goods and other unique or collectible physical items (including metal, glass, wood, leather and plastic materials). While the Hashed QR method solves all the major digital security and permanence problems, the laser engraving technique is required to solve many physical security and permanence problems. In its simplest form the present invention integrates specific hardware and software components to solve a range of specific physical and digital security and permanence problems that have previously characterized NFTs for physical asset applications in all prior art. Consequently, the present invention constitutes the first practical and commercially viable system and method for the secure, permanent application of NFTs as digital proofs of ownership for physical items, including but not limited to unique luxury products and goods. Importantly, all NFT ownership and transaction details are fully traceable because they are stored on a blockchain network.

### BRIEF DESCRIPTION OF THE DRAWINGS

In order that the present invention can be more clearly ascertained, embodiments will now be described, by way of example, with reference to the accompanying drawings, in which:

FIG. 1 is a schematic diagram of an illustrative prior art system and method for creating NFTs for unique physical items using a single QR code twice; namely used in 1) the physical format via conventional printing methods on the physical item or attached label, and 2) the digital format via the permanent linking of the QR code with a unique NFT.

FIG. 2 displays three illustrative prior art examples of typical graphical code formats for machine-readable (or optically scannable) information codes used twice as the intermediary link in prior art between a unique physical item and a digital NFT, including 1) a 1D barcode, 2) a square 2D data matrix or QR code, and 3) a circular 2D data matrix or QR code.

FIG. 3 is a schematic diagram of the present invention in its simplest configuration, displaying the system and method for the two essential processes that execute the key functions of 1) creation or minting of an NFT for a unique physical item using 3 different standard 2D square QR codes and laser engraving, and 2) verification or proof of ownership of an NFT and its linked physical item using 3 different 2D square QR codes and optical scanning.

FIG. 4 is a schematic diagram of the present invention in a hybrid information code format, displaying the systems and methods for the two essential processes that execute the key functions of 1) creation or minting of an NFT for a unique physical item using a 2D circular graphical QR code and 2 other non-graphical information codes, and 2) verification or proof of ownership of an NFT and its linked physical item using a 2D circular graphical QR code and 2 other non-graphical information codes.

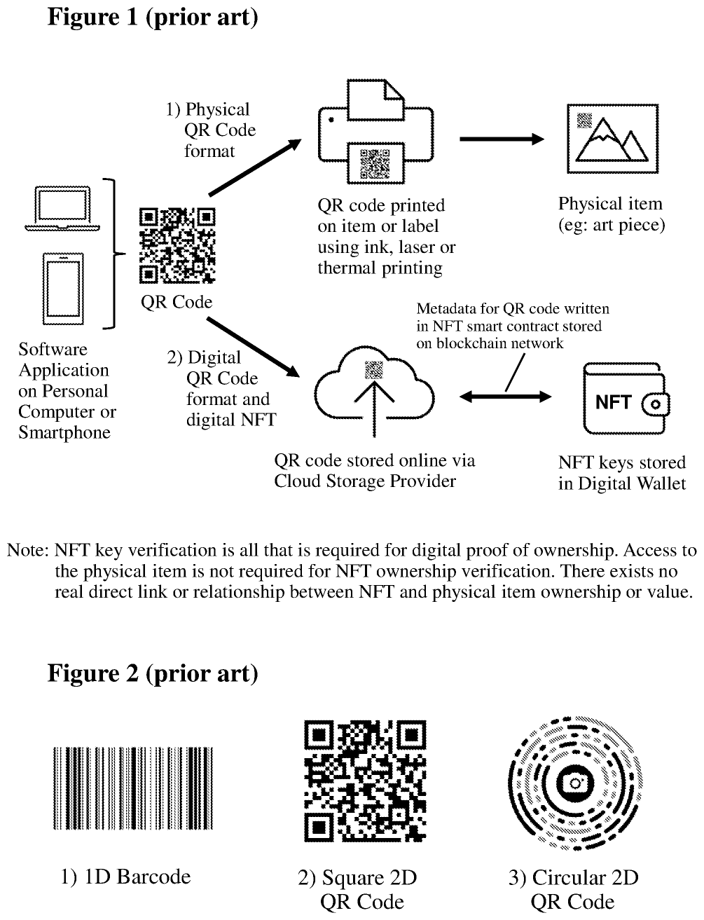

### DETAILED DESCRIPTION OF THE INVENTION

The present invention describes a system and method comprising two essential processes or aspects, that each include multiple sub-processes or steps, for the specific purposes of (1) the creation or minting of an NFT linked to a unique physical item or asset, and (2) the verification or proof of ownership of both the NFT and the linked physical item or asset. As a first essential process or aspect, the present invention utilizes the application of the Hashed QR method with various laser engraving techniques for the successful execution of the NFT creation or minting process. As a second essential process or aspect, the present invention also utilizes the application of the Hashed QR method with various optical scanning techniques for the successful execution of the NFT verification or proof of ownership process.

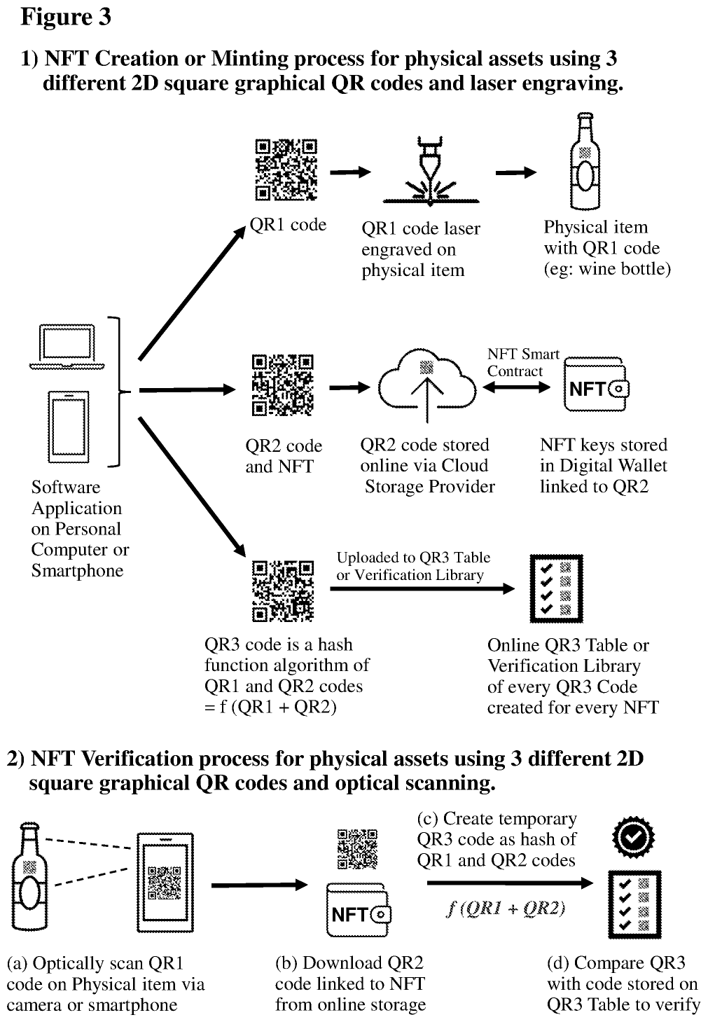

In a first embodiment of the present invention, an overview schematic incorporating both (1) the NFT minting process and (2) the NFT verification process, using the Hashed QR method with three different graphical square QR codes, laser engraving and optical scanning techniques, is detailed in FIG. 3. More specifically in this first embodiment, the system and method of the present invention includes eight sub-processes or steps, referred to as steps 1(a), 1(b), 1(c), 1(d), 1(e), 1(f), 1(g) and 1(h) below, to fully execute the initial “one-off” NFT creating or minting process, using the described apparatus or device for implementation as follows:
(1) Creation or minting of an NFT linked to a unique physical item, using an integrated hardware and software device (referred to as a LaserMinter device), that executes the following steps:
   a) Creates a graphical 2D square information code or QR code called QR1 for the physical environment format.
   b) Laser engraves the QR1 code onto the physical asset or item (or attachable label).
   c) Creates a second different graphical information code or QR code called QR2 for the digital environment format.
   d) Stores the digital file for the QR2 code online using a cloud storage provider, preferably on a decentralized file storage platform for improved data security.
   e) Creates or mints a new NFT digital identifier using an appropriate blockchain network protocol and its linkage to the QR2 code via incorporation into the NFT smart contract of the metadata, internet address or URL for the QR2 code that is stored online as per step (1e).
   f) Creates a third different graphical information code or QR code called QR3 by applying either a standard or proprietary mathematical hash transformation, such as an irreversible hash algorithm that combines the data from QR1 and QR2 to produce a new unique combination QR code or proprietary data code QR3 for that specific NFT, that will be used in future for the verification of ownership of both the NFT and physical item via process (2) below.
   g) Uploads the QR3 code used for verification purposes to an online library, table, account ledger or blockchain network that permanently stores every QR3 code for every NFT ever created or minted by a LaserMinter device.
   h) Uploads, stores or transfers the encryption keys for access to the newly created NFT to the user's personal or assigned digital wallet for storing crypto-currency and NFTs, preferably using an encrypted online digital wallet for improved data security and ease of use.
      In this first embodiment, the system and method of the present invention also includes four sub-processes or steps, referred to as steps 2(a), 2(b), 2(c) and 2(d) below, to fully execute the subsequent and “repeatable” NFT verification process, using the described apparatus or device for implementation as follows:
(2) Verification or proof of ownership of a minted NFT linked to a unique physical item created by a LaserMinter device, using software on a common user-device such as a smartphone, personal computer equipped with a camera, or similar code scanning and data processing apparatus, that executed the following steps:
   a) Scans the QR1 code that has been laser engraved onto a unique physical item using an optical scanner, camera, QR code reader or similar machine-readable smart phone application available on the user-device.
   b) Accesses the NFT private key that is stored in the user's personal digital wallet, then use the NFT approved access to download or retrieve the QR2 code that and has been stored online using the cloud storage provider and is digitally linked to the NFT via the metadata in the NFT smart contract.
   c) Temporarily creates a third information code or QR code called QR3 by applying a mathematical hash transformation, such as an irreversible hash algorithm that combines the data from QR1 and QR2 to produce a new unique combination QR code or proprietary data file QR3.
   d) Downloads the permanent online QR3 code for the minted NFT from the online library, table, account ledger or blockchain network that permanently stores every QR3 code for every NFT ever minted by a LaserMinter device, and then compares the temporary QR3 code created in step 2(c) above with the permanent online version of the QR3 code that is stored in the online library, table or blockchain network described in steps 1(f) and 1(g) above to verify the user's ownership of both the NFT and the linked physical asset.

It is instructive to note that for the NFT minting process described above in (1), and for the NFT verification process described above in (2), the specific order of the incorporated sub-processes or steps (1a) to (1h), and steps (2a) to (2d) are not fixed or critical in order and may vary in sequence for the equivalent sum effect. Consequently, many variations of the sequence of steps involved in processes (1) and (2) may be possible, and several steps may even be performed simultaneously or in parallel with other steps. However, the total or sum effect of all executable sub-processes or steps for each process should not vary or change in any way. Regardless of specific order, all steps for each process are required to be executed in full such that the end total result is the same as described in processes (1) and (2) above. It is also instructive to note that the designation of QR codes as QR1, QR2 and QR3 may refer to any machine-readable graphical information code such as a 1D barcode, 2D data matrix code or standardized quick response code (collectively referred to here as QR codes). Furthermore, it should be noted that for the digital QR codes designated as QR2 and QR3, the designation may also refer to non-graphical codes such as numeric, alphanumeric, hexadecimal or binary data codes or text strings. Only the physical QR code designated QR1 is required to be in the format of a machine-readable graphical information code such as a 1D barcode or a 2D quick response code (collectively called QR codes). Consequently, alternative configurations (or hybrid configurations) of the present invention may only include a single 2D graphical QR code for the physical environment and use non-graphical codes for the digital and verification codes.

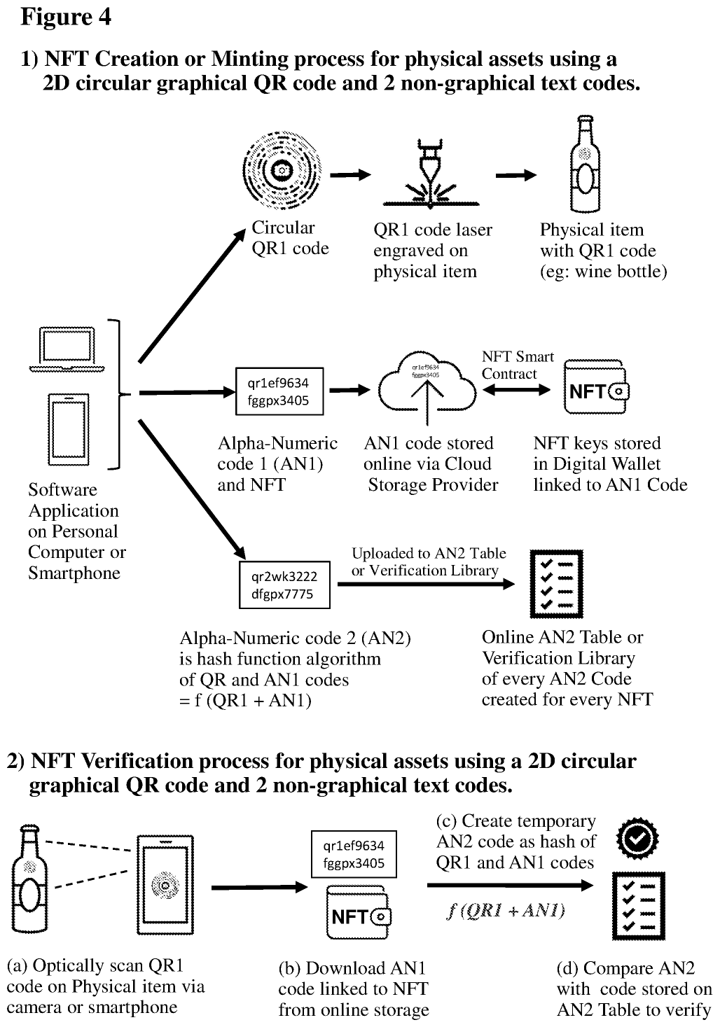

By way of example of an alternative configuration, in a second embodiment of the present invention, an overview schematic incorporating both (1) the NFT minting process and (2) the NFT verification process, using the Hashed QR method with one graphical 2D circular QR code, two non-graphical text codes, laser engraving and optical scanning techniques, is detailed in FIG. 4. In this second embodiment of the present invention, the initial NFT minting process and subsequent NFT verification process have identical sub-processes or steps as described in 1(a) through 1(h), and 2(a) through 2(d) above, except that the 2D square graphical code QR1 is replaced with a 2D circular graphical code also labelled QR1, the graphical code labelled QR2 is replaced by an equivalent non-graphical text code AN1, and the graphical code labelled QR3 is replaced by an equivalent non-graphical text code labelled AN2. For the purposes of additional alternative configurations of the present invention, both non-graphical text codes AN1 and AN2 may independently take the form of either alpha-numeric, numeric, hexadecimal or binary text codes. Consequently, due to the numerous possible variations of sub-processes 1(a) through 1(h) and 2(a) through 2(d), and due to the numerous possible variations of both 2D graphical codes and non-graphical codes, the present invention that is broadly described in the two embodiments may have many possible variations that all meet the requirements of processes (1) and (2) above.

It is an important and essential feature of all possible embodiments of the present invention that the verification code (referred to as QR3 in FIG. 3 and AN2 in FIG. 4) is created from the input of a 2D graphical code in the physical format, and either a 2D graphical code or a non-graphical code in the digital format, via a mathematical hash function that is one-directional or irreversible by inherent nature (as opposed to similar mathematical functions such as reversible encryption or encoding functions). This essential requirement for an irreversible hash function to create the verification code prevents the creation or derivation of the physical and digital input codes (referred to as QR1 and QR2 in FIG. 3, and as QR1 and AN1 in FIG. 4) from the verification output code. If a reversible mathematical function was used instead of a hash function this would result in significantly reduced levels of data security and enable additional methods and possibilities for copying and forgery of the information codes. Examples of suitable irreversible hash functions include, but are not limited to, secure hash algorithms such as SHA-1, SHA-256 and SHA-512, message digest algorithms such as MD1, MD2 and MD5, the HAVAL hash algorithm, the RIPEMD hash algorithm and the Whirlpool hash algorithm.

In all possible embodiments of the present invention, including those detailed in FIG. 3 and FIG. 4, it is essential for the second NFT verification purpose that the user or owner of the NFT executes all four steps above from (2a) through to (2d) above to gain approved access to the NFT when it is required for activities including the sale, auction or transfer of the NFT to a third party, and the update of NFT related data. Note that all four steps (2a) through (2d) cannot be fully completed unless the user or owner is in direct possession of both the digital NFT and the actual physical item for optical scanning. Without the physical item it is not possible to verify the ownership of the NFT and hence the NFT becomes effectively useless. Consequently, the perceived value of the NFT should now be directly related to the value of the unique physical item. Furthermore, a physical asset can now be effectively sold or auctioned online by selling it's associated NFT (assuming suitable freight, warehousing and escrow services can be provided for both the buyer and seller).

As discussed previously above, the use of laser engraving techniques in the LaserMinter device is the preferred system for the present invention to ensure maximum security and permanency of the physical QR code (or QR1 code) that marks the physical item. Numerous laser engraving or laser marking techniques are possible with varying degrees of resolution and marking quality. The quality, resolution and practicality of the engraved QR1 code on the physical item (or attached physical label) depends both on the material of the physical item (or label) and on the optical parameters of the laser device including laser wavelength, average optical power, peak optical power, optical mode structure, focusable spot size. However, most typical materials for physical items can be laser engraved to sufficient quality and resolution using one of two types of laser devices, namely an infrared (IR) laser or an ultra-violet (UV) laser. Most metal, woods and plastic materials can be suitably marked using an infrared or IR laser with an output wavelength in the 1000 nm to 1100 nm spectral region and an average optical output power between 2 Watts and 20 Watts. Examples of such IR lasers include, but are not limited to, a solid-state Nd based laser, a fiber laser and a semiconductor diode laser. Conversely, most glass materials can be suitably marked using an ultra-violet or UV laser with an output wavelength near 350 nm to 410 nm spectral region and an average optical output power of between 2 Watts and 20 Watts. Examples of such UV lasers include, but are not limited to, a frequency tripled Nd based laser or fiber laser, and a semi-conductor diode laser.

Conversely, it is important to note that replacement of the laser engraver component in the LaserMinter device with a less permanent printing technology (such as an inkjet printer, laser printer or thermal printer) can be performed without significantly affecting the level of innovation and novelty of the present invention based on the Hashed QR method. Furthermore, although the laser engraving component is the preferred apparatus and method for marking the physical QR1 code on most intended physical materials such as metal, wood, plastic or glass, there may be some specific applications, materials, products or use cases where the permanence and security of the physical QR1 code is not of upmost importance. Consequently, the present invention may also incorporate the Hashed QR method with non-permanent printing techniques as the preferred embodiment due to the limited lifetime of the physical material of the item, or due to commercial reasons that require a much cheaper, more broadly accessible and portable method for printing the physical QR1 code onto the physical item or attached label. For the purpose of clarity, the present invention also includes all possible embodiments that use the novel Hashed QR method with non-permanent printing techniques (such as inkjet, laser or thermal printing) instead of using the permanent laser engraving technique to mark the physical item.

In addition to the laser engraving technique being a key part of preferred configurations or embodiments of the present invention for most practical applications, there exist several other preferred embodiments of the present invention for the management and storage of digital QR codes and verification QR codes. In terms of the online cloud storage platform used to store the digital QR code (referred to as QR2 in FIG. 3 and as AN1 in FIG. 4) that is linked to the NFT and used in steps 1(d) and 2(b) above, preferred embodiments may utilize a decentralized cloud storage architecture instead of a centralized cloud storage architecture that is often used in prior art. The use of a decentralized cloud storage platform to store the digital QR code may dramatically improve the level of data security. Examples of suitable commercially available decentralized cloud storage products for this purpose include IPFS, Filecoin, Storj, Sia and Cryptyk cloud storage platforms. In terms of the online verification table or online library of all verification QR codes (referred to as QR3 in FIG. 3 and as AN2 in FIG. 4) used in steps 1(g) and 2(d) above, preferred embodiments may utilize a decentralized ledger technology or decentralized public blockchain network as the storage architecture. It is instructive to note that while the use of a public blockchain network to store all verification QR codes, there exist no problems or added security risk relating to the verification QR codes being publicly available to view due to the hash function algorithm used to create verification QR codes. Because the mathematical hash function in step 1(g) that uses physical and digital QR codes as inputs is irreversible, an unknown third party or bad actor may view the relevant verification QR code for a specific NFT, but they cannot derive or create the physical QR code or digital QR code for the NFT from the published verification QR code. Because blockchain networks are immutable in nature, the use of a decentralized blockchain network for the storage of all verification QR codes may dramatically improve data security and permanence. While the preferred embodiment of the present invention may necessitate the construction and deployment of a new application-specific layer 1 blockchain protocol and network for the specific purpose of physical NFT verification, it may also be possible through use of a layer 2 blockchain network built on top of an existing layer 1 blockchain network such as Ethereum or Solana. Alternatively, using a private permissioned blockchain such as Hyperledger may offer advantages for specific privacy applications. The potential range of blockchain designs that can be used for the purpose of storing QR codes to build online NFT verification tables is significant, with preferred embodiments of the present invention benefitting from the permanent, immutable nature of blockchain data storage.

The simplest and most efficient embodiment of the present invention uses the Hashed QR method with 3 different unique information codes or QR codes as detailed in both FIG. 3 and FIG. 4. However, there may exist some specialized applications where a fourth or even fifth unique QR code may be used for an added degree of data security, redundancy or flexibility in application. The requirement for three QR codes should be viewed as the minimum number possible. Therefore, all potential embodiments of the present invention may be best described as using the Hashed QR method with three or more different QR codes required for the purposes of NFT minting and NFT verification of physical assets or items in the real world.

In the descriptions of the present invention detailed here above, we have used the term “QR code” to generically define or represent any type of data information code, including but not limited to 1D and 2D graphical QR codes, alpha-numeric, numeric, hexa-decimal and binary text data codes. The only condition on data code type in the embodiments described above is that the physical QR1 code that is laser engraved, marked or printed on the physical item should be either a 1D or 2D graphical QR code, so that the QR1 Code can be easily scanned or read by an optical scanning device or camera on a smartphone, and then converted into a non-graphical or alpha-numeric text code or equivalent for processing using the hashed QR method. However, the present invention may also include preferred embodiments that use non-graphical data coding and reading methods for the QR1 Code, instead of 1D or 2D graphical codes as previously discussed. Preferred embodiments for the non-graphical QR1 code include, but are not limited to, the storage and reading of the QR1 code using an electronic semi-conductor chip for data storage and wireless communication technologies such as a Near-Field Communications (NFC) devices, RF communications devices, IoT, Wi-Fi and Bluetooth protocols for communicating the QR1 data code to a smartphone or personal computer device. As with all other preferred embodiments detailed here, once the QR1 code stored in a chip attached to the physical item is communicated to the smartphone via a wireless protocol, it can then be hashed via the desired Hashed QR method with the QR2 code to create the QR3 code used for NFT and physical item ownership verification purposes. Preferred embodiments of the present invention may provide added security or flexibility by using both an NFC chip device attached to or inserted inside the physical item, and the 2D graphical QR code format laser engraved on the physical item for the storage of the same QR1 information code. Hence users could either optically scan the graphical QR code or electronically scan an NFC chip to upload the stored physical QR1 code.

In the description of the present invention we have used the term “LaserMinter Device” to describe the system, apparatus and method for the initial process of minting the NFT. As part of this NFT minting process the LaserMinter device creates a new NFT, creates 3 different QR codes, laser engraves the QR1 code on the physical item, pairs the QR2 code online with the NFT, and uploads the QR3 code to the QR3 code online library. The present invention also includes embodiments that incorporate or integrate additional technologies and features into the LaserMinter device, including but not limited to 2D and 3D optical scanner devices for providing additional media or image files related to the physical item and digitally connectable to the NFT.

Due to the various technical features, unique capabilities and data security characteristics detailed above, the present invention can act as a legitimate digital ID verification tool for the sale, auction, transfer, marketing and promotion of all unique physical assets and their associated or paired NFTs. Moreover, the present invention can also act as an item provenance and value enhancer for any unique, valuable physical item or luxury product. By using the LaserMinter device as a system for the NFT minting process (described in process (1) above) for production or manufacturing applications, vendors and manufacturers of luxury products can both improve their brand name and increase the sale price of products by minting secure, permanent digital NFTs for each item that offer customers numerous online features and a digital history for every unique physical product or asset. The potential market scope for unique or collectible physical items which include their own digital proof of authenticity and digital ownership history appear significant. Moreover, the potential for earning sales commission fees and profit from offering the NFT verification process (described in process (2) above) as an essential part of the sale or auction of retail luxury goods and physical collectibles appears even more significant. Successful commercialization of the present invention may offer a unique market opportunity to legitimize the entire NFT industry for physical assets due to vastly improved levels of physical security, digital security, data permanence and item traceability.

What is claimed is:

1. A system and method for the creation or minting of a unique, non-fungible, digital identification token that is permanently linked to a unique physical item in the real-world via the creation and permanent distributed storage of three different information codes that include;
a first physical information code, such as a graphical QR code or barcode, that is permanently laser-engraved or laser-marked onto the surface of the unique physical item;
a second digital information code that is uploaded to a publicly accessible network or the internet and stored online, and permanently connected or paired to the unique digital identification token which is recorded on a public blockchain network for immutable and traceable verification of ownership of the second digital information code; and
a third permanent digital information code or verification code that is created via algorithmically combining or hashing the first graphical information code with the second digital information code into a third information code, that is then uploaded and permanently stored in an online verification library, for future access to verify the authenticity or ownership of the unique physical item and unique digital identification token.

2. A system and method for the verification of ownership or authenticity of a unique physical item in the real-world that is permanently linked to a unique, non-fungible, digital identification token via the data retrieval, processing and verification of three different information codes using a personal user device such as a camera, smartphone, tablet, personal computer, or similar computer-controlled device, including the following steps or operations;
retrieval of a first physical information code, such as a graphical QR code or barcode, that is permanently laser-engraved on the surface of the unique physical item using the optical scanning, image processing and data processing functions of the personal user device on the unique physical item;
retrieval of a second digital information code that is permanently connected or paired to the unique digital identification token which is recorded on a public blockchain network, using the digital wallet and online data communications functions on the personal user device;
creation of a third temporary digital information code or verification code using the data processing functions on the personal user device to algorithmically combine or hash the first graphical information code with the second digital information code into the third temporary information code; and
comparison of the third temporary digital information or verification code generated by the personal user device with a permanent digital information or verification code for the unique physical item, that has been previously created, uploaded, and stored in an online verification library during an initial digital verification code creation or minting process, to verify the authenticity or ownership of the unique physical item and the unique digital identification token.

3. A system and method for claim 1, wherein the creation of the first physical information code is not created in the form of a graphical information code laser engraved onto the surface of the unique physical item, but is instead created in the form of a digital wireless, radio frequency (RF) or near-field communication (NFC) information code stored in or emitted from a semiconductor chip device that is attached to the unique physical item, or permanently included as an intrinsic component part of the unique physical item.

4. A system and method for claim 2, wherein retrieval of the first physical information code is not via the optical scanning of a graphical information code laser engraved onto the surface of the unique physical item, but retrieval is instead achieved via the wireless scanning, connection and communications by the personal user device of a digital wireless, radio frequency (RF) or near-field communication (NFC) information code that is stored in or emitted by a semiconductor chip device that is attached to the unique physical item, or permanently included as an intrinsic component part of the unique physical item.

5. A system and method for claim 1, wherein there is created not three but four or more different information codes, with two or more different physical graphical information codes being created via laser engraving on multiple different physical components of the physical item, and algorithmically combined or hashed together with the second digital information code to form the third permanent verification code which is then uploaded and stored in an online verification library.

6. A system and method for claim 2, wherein not three but four or more different information codes are retrieved by the personal user device, with two or more different physical graphical information codes being optically scanned from multiple different physical components of the physical item, and algorithmically combined or hashed together with the second digital information code to form the third temporary verification code, which is then compared with the permanent verification that is stored in an online verification library for the purpose of verifying the authenticity or ownership of multiple different physical components of the physical item.

7. A system and method for claim 1, wherein the permanent laser engraving of the first graphical information code engraved on the unique physical item is achieved via the use of either ultraviolet (UV), visible (VIS) or infrared (IR) optical radiation from a high-power laser device.

8. A system and method for claim 2, wherein the optical scanning of the first graphical information code engraved on the unique physical item is achieved via optical scanning in either the ultraviolet (UV), visible (VIS) or infrared (IR) regions of the electromagnetic spectrum.

9. A system and method for claim 1, wherein the first physical graphical information code is not laser engraved on the surface of the unique physical item but is instead printed onto the surface of the physical item using an inkjet printer, laser printer, thermal printer, dye sublimation printer or similar printing technology.

10. A system and method for claim 1, wherein the first physical graphical information code is not laser engraved on the surface on the unique physical item but is instead either laser engraved or printed onto a separate physical label or tag that is attached to the unique physical item.

11. A system and method for claim 1, wherein the first physical graphical information code on the unique physical item is engraved via the use of mechanical engraving, photoengraving, chemical etching, or dual laser source holographic engraving instead of laser engraving from a single optical laser device.

12. A system and method for claim 1 or claim 2, wherein the online verification library is in the form of a private or permissioned blockchain network, a public blockchain network or similar immutable database network.

13. A system and method for claim 1 or claim 2, wherein the online verification library that stores the permanent verification codes for all minted physical items is routinely scanned and analyzed by cyber-security, artificial intelligence or machine learning software for various purposes including user behavior prediction, user tracking, physical item tracking, ownership tracking, sales tracking, theft identification and counterfeit identification.

14. A system and method for claim 2, wherein the owner of the unique physical item and the unique digital identification token can create a temporary verification code to authenticate the physical item, verify ownership status of the physical item, or approve the sale or transfer of the physical item and digital identification token.

15. A system and method for claim 2, wherein the owner of the unique physical item and the unique digital identification token can create a temporary verification code to access an online cloud storage account that is associated with the physical item and digital identification token, for the purpose of storing digital files that are related to or associated with the physical item.
